(19) United States
(12) Patent Application Publication
(10) Pub. No.: US 2012/0252659 A1
(43) Pub. Date: Oct. 4, 2012

(54) CATALYST COMPOSITIONS AND APPLICATIONS THEREOF

(75) Inventor: Chris E. DiFrancesco, Durham, NC (US)

(73) Assignee: Cormetech, Inc., Durham, NC (US)

(21) Appl. No.: 13/433,197

(22) Filed: Mar. 28, 2012

Related U.S. Application Data
(60) Provisional application No. 61/468,301, filed on Mar. 28, 2011.

(51) Int. Cl. B01J 21/06; B01J 21/16; B01J 23/28; B01J 23/648; B01J 23/68; B01J 23/36; B01J 23/22; B01J 23/30

(52) U.S. Cl. 502/84; 502/353; 502/304; 502/312; 502/325; 502/339; 502/344; 502/350; 502/309

(57) ABSTRACT

Structural catalyst bodies are described herein which, in some embodiments, can be used in the treatment of nitrogen oxides present in exhaust or flue gases from stationary or mobile combustion sources. In some embodiments, a structural catalyst body described herein comprises an outer peripheral wall and a plurality of inner partition walls having an average thickness less than about 0.5 mm, the outer peripheral wall and the inner partition walls having dispersed throughout a chemical composition comprising 50-99.9% by weight an inorganic oxide composition, less than 3% by weight an inorganic extrusion aid and at least 0.1% by weight a catalytically active metal functional group comprising vanadium, the structural catalyst body having a crystalline vanadium pentoxide content less than 0.1 weight percent.

### RELATED APPLICATION DATA

The present application claims priority pursuant to 35 U.S.C. §119(e) to U.S. Provisional Patent Application Ser. No. 61/468,301, filed Mar. 28, 2011, which is hereby incorporated by reference in its entirety.

### FIELD OF THE INVENTION

The present invention relates to catalyst compositions and, in particular, to structural catalyst bodies.

### BACKGROUND OF THE INVENTION

The toxicity of nitrogen oxides and their role in the formation of acid rain and tropospheric ozone have resulted in the imposition of strict standards limiting the discharges of these chemical species. To meet these standards, it is generally necessary to remove at least part of these oxides present in exhaust or flue gases from stationary or mobile combustion sources.

Denitration or selective catalytic reduction (SCR) technology is commonly applied to combustion-derived gases for removal of nitrogen oxides. Selective catalytic reduction generally comprises the reaction of nitrogen oxide species in the gases, such as nitric oxide (NO) and/or nitrogen dioxide (NO₂), with a nitrogen containing reductant, such as ammonia or urea, resulting in the production of nitrogen gas (N₂) and water.

### SUMMARY

Catalyst compositions are described herein which, in some embodiments, can be used in the treatment of nitrogen oxides present in exhaust or flue gases from stationary or mobile combustion sources. In some embodiments, catalyst compositions described herein comprise monolithic structural catalyst bodies.

A structural catalyst body described herein, in some embodiments, comprises an outer peripheral wall and a plurality of inner partition walls having an average thickness less than about 0.5 mm, the outer peripheral wall and the inner partition walls having dispersed throughout a chemical composition comprising 50-99.9% by weight an inorganic oxide composition, less than 3% by weight an inorganic extrusion aid and at least 0.1% by weight a catalytically active metal functional group comprising vanadium, the structural catalyst body having a crystalline vanadium pentoxide content less than 0.1 weight percent as determined by X-ray diffraction with reference to the International Centre for Diffraction Data (ICDD) powder diffraction file 00-041-1426. In some embodiments, the structural catalyst body has crystalline vanadium pentoxide content less than 0.05 weight percent as determined by X-ray diffraction with reference to ICDD powder diffraction file 00-041-1426.

In some embodiments, the chemical composition forming the outer peripheral wall and inner partition walls of a structural catalyst body described herein comprises no or substantially no inorganic extrusion aid.

In another aspect, methods of producing structural catalyst bodies are described herein. In some embodiments, a method of producing a structural catalyst body comprises providing a chemical composition comprising 50-99.9% by weight an inorganic oxide composition, less than 3% by weight an inorganic extrusion aid and at least 0.1% by weight a catalytically active metal functional group comprising vanadium, forming the chemical composition into a monolithic structure comprising an outer peripheral wall and a plurality of inner partition walls having an average thickness less than about 0.5 mm and heating the monolithic structure to provide the structural catalyst body having a crystalline vanadium pentoxide content less than 0.1 weight percent as determined by X-ray diffraction with reference to ICDD powder diffraction file 00-041-1426. In some embodiments, the structural catalyst body has a crystalline vanadium pentoxide content less than 0.05 weight percent as determined by X-ray diffraction with reference to ICDD powder diffraction file 00-041-1426.

In some embodiments, a method of producing a structural catalyst body comprises providing a chemical composition comprising up to 100% by weight an inorganic oxide composition and less than 3% by weight an inorganic extrusion aid, forming the chemical composition into a monolithic structure comprising an outer peripheral wall and a plurality of inner partition walls having an average thickness less than about 0.5 mm, impregnating the monolithic structure with at least 0.1 percent by weight a catalytically active metal functional group comprising vanadium and heating the monolithic structure to provide the structural catalyst body having a crystalline vanadium pentoxide content less than 0.1 weight percent as determined by X-ray diffraction with reference to ICDD powder diffraction file 00-041-1426. In some embodiments, the structural catalyst body has a crystalline vanadium pentoxide content less than 0.05 weight percent as determined by X-ray diffraction with reference to ICDD powder diffraction file 00-041-1426.

In some embodiments, the monolithic structure formed of the chemical composition comprising up to 100% by weight an inorganic oxide composition and less than 3% by weight an inorganic extrusion aid is heated prior to impregnating with the catalytically active metal functional group.

In some embodiments, the chemical composition forming the outer peripheral wall and inner partition walls of a structural catalyst body according to a method described herein comprises no or substantially no inorganic extrusion aid.

In another aspect, methods of inhibiting the formation of crystalline vanadium pentoxide in a structural catalyst body are described herein. In some embodiments, a method of inhibiting the formation of crystalline vanadium pentoxide in a structural catalyst body comprises varying the amount of inorganic extrusion aid in the chemical composition forming the outer peripheral wall and/or inner partition walls of the structural catalyst body. In some embodiments, varying the amount of inorganic extrusion aid comprises reducing the amount of inorganic extrusion aid in the chemical composition forming the outer peripheral wall and/or inner partition walls of the structural catalyst body. In some embodiments, reducing the amount of inorganic extrusion aid comprises providing a chemical composition comprising no or substantially no inorganic extrusion aid.

In another aspect, methods of reducing the nitrogen oxide content of a fluid are described herein. In some embodiments, a method of reducing the nitrogen oxide content of a fluid comprises flowing the fluid through a structural catalyst body comprising an outer peripheral wall and a plurality of inner partition walls having an average thickness less than about 0.5 mm, the outer peripheral wall and the inner partition walls having dispersed throughout a chemical composition comprising 50-99.9% by weight an inorganic oxide composition, less than 3% by weight an inorganic extrusion aid and at least 0.1% by weight a catalytically active metal functional group comprising vanadium, the structural catalyst body having a crystalline vanadium pentoxide content less than 0.1 weight percent as determined by X-ray diffraction with reference to ICDD powder diffraction file 00-041-1426 and selectively catalytically reducing at least some of the nitrogen oxides in the fluid.

In some embodiments of methods of reducing the nitrogen oxide content of a fluid, the chemical composition forming the outer peripheral wall and inner partition walls of the structural catalyst body comprises no or substantially no inorganic extrusion aid.

In some embodiments, a fluid flowed through the structural catalyst body comprises an exhaust or a flue gas stream. In some embodiments, an exhaust gas stream or flue gas stream suitable for treatment with a structural catalyst body described herein is generated by a stationary combustion source. In some embodiments, an exhaust gas stream or a flue gas stream suitable for treatment with a structural catalyst body described herein is generated by a mobile combustion source.

These and other embodiments are presented in greater detail in the detailed description which follows.

### BRIEF DESCRIPTION OF THE FIGURES

FIG. 1 illustrates a perspective view of a honeycomb-like monolithic structural catalyst body according to one embodiment described herein.

FIG. 2 illustrates a method of determining average inner partition wall thickness according to one embodiment described herein.

FIG. 3 illustrates a sectional view of a structural catalyst body according to one embodiment described herein.

FIG. 4 is an X-ray diffractogram of the chemical composition forming the outer peripheral wall and inner partition walls of a structural catalyst body according to one embodiment described herein.

FIG. 5 is an X-ray diffractogram of the chemical composition forming the outer peripheral wall and inner partition walls of a prior art structural catalyst body.

### DETAILED DESCRIPTION

Embodiments described herein can be understood more readily by reference to the following detailed description and examples and their previous and following descriptions. Elements, apparatus and methods described herein, however, are not limited to the specific embodiments presented in the detailed description and examples. It should be recognized that these embodiments are merely illustrative of the principles of the present invention. Numerous modifications and adaptations will be readily apparent to those of skill in the art without departing from the spirit and scope of the invention.

In one aspect, catalyst compositions are described herein which, in some embodiments, can be used in the treatment of nitrogen oxides present in exhaust or flue gases from stationary or mobile combustion sources. In some embodiments, catalyst compositions described herein comprise monolithic structural catalyst bodies.

A structural catalyst body described herein, in some embodiments, comprises an outer peripheral wall and a plurality of inner partition walls having an average thickness less than about 0.5 mm, the outer peripheral wall and the inner partition walls having dispersed throughout a chemical composition comprising 50-99.9% by weight an inorganic oxide composition, less than 3% by weight an inorganic extrusion aid and at least 0.1% by weight a catalytically active metal functional group comprising vanadium, the structural catalyst body having a crystalline vanadium pentoxide content less than 0.1 weight percent as determined by X-ray diffraction with reference to ICDD powder diffraction file 00-041-1426. In some embodiments, the structural catalyst body has crystalline vanadium pentoxide content less than 0.05 weight percent as determined by X-ray diffraction with reference to ICDD powder diffraction file 00-041-1426.

Moreover, in some embodiments, the chemical composition dispersed throughout the outer peripheral wall and inner partition walls of a structural catalyst body described herein comprises at least 0.5% by weight a catalytically active metal functional group comprising vanadium. The chemical composition, in some embodiments, comprises at least 1% by weight or at least 1.5% by weight a catalytically active metal functional group comprising vanadium.

Turning now to components of structural catalyst bodies described herein, structural catalyst bodies described herein comprise an outer peripheral wall and inner partition walls. The inner partition walls are arranged within the outer peripheral wall and define a plurality of flow channels extending longitudinally through the structural catalyst body.

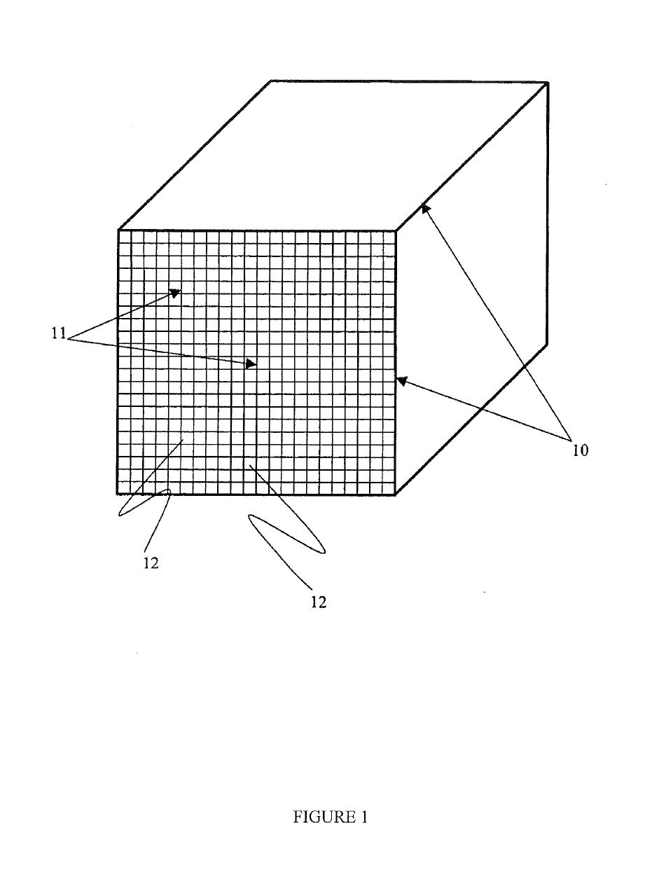

FIG. 1 illustrates a structural catalyst body according to one embodiment described herein. The monolithic structural catalyst body of FIG. 1 comprises a catalytically active outer peripheral wall (10) and a plurality of catalytically active inner partition walls (11). As illustrated in FIG. 1, the inner partition walls (11) define a plurality of flow channels or cells (12) which extend longitudinally through the structural catalyst body for receiving exhaust or flue gases from a combustion source.

The inner partition walls of a structural catalyst body described herein, in some embodiments, have an average thickness less than about 0.5 mm. In some embodiments, the inner partition walls have an average thickness less than about 0.45 mm or less than about 0.4 mm. The inner partition walls, in some embodiments, have an average thickness less than about 0.35 mm or less than about 0.3 mm. In some embodiments, the inner partition walls have an average thickness less than about 0.25 mm or less than about 0.2 mm. The inner partition walls of a structural catalyst body described herein, in some embodiments, have an average thickness ranging from about 0.05 mm to about 0.5 mm. In some embodiments, the inner partition walls have an average thickness ranging from about 0.1 mm to about 0.5 mm or from about 0.2 mm to about 0.45 mm. In some embodiments, the inner partition walls have an average thickness ranging from about 0.25 mm to about 0.5 mm. The inner partition walls, in some embodiments, have an average thickness ranging from about 0.27 mm to about 0.5 mm. In some embodiments, the inner partition walls have an average thickness ranging from about 0.25 mm to about 0.45 mm or from about 0.27 mm to about 0.43 mm. In some embodiment, the inner partition walls have an average thickness ranging from about 0.3 mm to about 0.5 mm or from about 0.3 mm to about 0.45 mm.

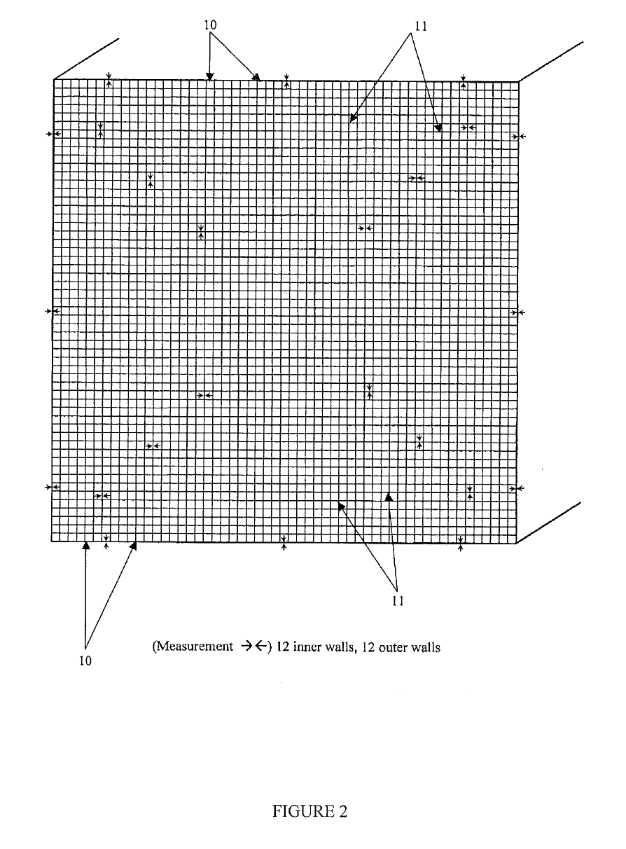

The thicknesses of the inner partition walls as well as the outer peripheral wall, in some embodiments, can be determined with a caliper or micrometer with a resolution of at least 0.01 mm. FIG. 2 illustrates one method of determining the average wall thickness of the outer peripheral wall (10) and inner partition walls (11) of a structural catalyst body according to one embodiment described herein. The thickness of the outer peripheral wall (10) is measured in twelve different locations on the structural catalyst body. In some embodiments when the structural catalyst body has a square or rectangular cross-sectional shape, the twelve measuring locations comprise three points on each side of the square or rectangular outer peripheral wall (10) as displayed in FIG. 2. The average thickness of the outer peripheral wall is (10) is then calculated by averaging the values obtained by the twelve measurements. Similarly, the average thickness of the inner partition walls (11), in some embodiments, is determined by measuring the thickness of the inner partition walls (11) at twelve different locations throughout the structural catalyst body. The inner partition walls (11) are measured in the horizontal and vertical directions as illustrated in FIG. 2. The average thickness of the inner partition walls (11) is then calculated by averaging the values obtained in the twelve measurements.

In some embodiments, the outer peripheral wall and the inner partition walls of a structural catalyst body described herein have dispersed throughout a chemical composition comprising 50-99.9% by weight an inorganic oxide composition, less than 3% by weight an inorganic extrusion aid and at least 0.1% by weight a catalytically active metal functional group comprising vanadium. The inorganic oxide composition, in some embodiments, comprises titania (TiO₂), alumina (Al₂O₃), zirconia (ZrO₂), silica (SiO₂) or mixtures thereof. In some embodiments, for example, the inorganic oxide composition comprises titania alone. In some embodiments, the chemical composition comprises an inorganic oxide composition of TiO₂, Al₂O₃, ZrO₂ or SiO₂ or mixtures thereof in an amount ranging from about 70 weight percent to about 95 weight percent. In one embodiment, the inorganic oxide composition comprises 70 weight percent to about 95 weight percent TiO₂.

In being dispersed throughout the outer peripheral wall and/or inner partition walls, the catalytically active metal functional group comprising vanadium, in some embodiments, is part of the chemical composition extruded to form the outer peripheral wall and/or inner partition walls. Alternatively, in some embodiments, the catalytically active metal functional group comprising vanadium is dispersed throughout the outer peripheral wall and/or inner partition walls by impregnation after formation of the walls.

Moreover, in some embodiments, an inorganic extrusion aid of the chemical composition can comprise one or a plurality of species of inorganic extrusion aids. In some embodiments, an inorganic extrusion aid of the chemical composition comprises one or more clays. In some embodiments, a clay comprises one or more species of the smectite group. In some embodiments, for example, a clay comprises aliettite, beidellite, hectorite, montmorillonite, nontronite, saponite, sauconite, stevensite, swinefordite, volkonskoite, yakhontovite or zincsilite or mixtures thereof.

In some embodiments, a clay of an inorganic extrusion aid has a SiO₂ content of at least about 70 weight percent. In some embodiments, a clay has a SiO₂ content ranging from about 70 weight percent to about 80 weight percent. In some embodiments, a clay has a SiO₂ content ranging from about 70 weight percent to about 75 weight percent or from about 71 weight percent to about 74 weight percent. Additionally, in some embodiments, a clay of an inorganic extrusion aid has an Al₂O₃ content ranging from about 10 weight percent to about 20 weight percent. A clay, in some embodiments, has an Al₂O₃ content ranging from about 11 weight percent to about 18 weight percent or from about 12 weight percent to about 16 weight percent.

In some embodiments, a clay of an inorganic extrusion aid has an RO (metal oxide) content of up to about 5 weight percent, wherein R is an alkaline earth metal including, but not limited to, calcium and/or magnesium. In some embodiments, a clay comprises a mixture of alkaline earth metal oxides. In some embodiments, a clay comprises RO in an amount ranging from about 0.1 weight percent to about 5 weight percent or from about 0.5 weight percent to about to 4.5 weight percent. In some embodiments, a clay comprises RO in an amount ranging from about 1 weight percent to about 4 weight percent or from about 1.5 weight percent to about 3.5 weight percent. In one embodiment, for example, a clay of an inorganic extrusion aid comprises CaO in an amount ranging from about 0.1 weight percent to about 2 weight percent and MgO in an amount ranging from about 1 weight percent to about 4 weight percent.

Additionally, in some embodiments, a clay of an inorganic extrusion aid comprises one or more transition metal oxides. In some embodiments, a clay comprises Fe₂O₃. A clay, in some embodiments, comprises Fe₂O₃ in an amount up to about 5 weight percent. In some embodiments, a clay comprises Fe₂O₃ in an amount ranging from about 0.1 weight percent to about 5 weight percent or from about 0.5 weight percent to about 4.5 weight percent. In some embodiments, a clay comprises Fe₂O₃ in an amount ranging from about 1 weight percent to about 4 weight percent or from about 2 weight percent to about 4.5 weight percent.

An inorganic extrusion aid including, but not limited to, any clay described herein, in some embodiments, is present in the chemical composition forming the outer peripheral wall and/or the inner partition walls of a structural catalyst body in an amount up to 3 weight percent. In some embodiments, an inorganic extrusion aid is present in the chemical composition in an amount up to 2.7 weight percent or up to 2.5 weight percent. An inorganic extrusion aid, in some embodiments, is present in the chemical composition in an amount up to 2.3 weight percent or up to 2 weight percent. In some embodiments, an inorganic extrusion aid is present in the in the chemical composition in an amount up to 1.7 weight percent or 1.5 weight percent. An inorganic extrusion aid, in some embodiments, is present in the chemical composition in an amount up to 1 weight percent or 0.5 weight percent. In some embodiments, an inorganic extrusion aid is present in the chemical composition in an amount up to 0.1 weight percent.

In some embodiments, an inorganic extrusion aid, including any clay described herein, is present in the chemical composition forming the outer peripheral wall and/or the inner partition walls of a structural catalyst body in an amount ranging from 0.01 weight percent to 3 weight percent. An inorganic extrusion aid, in some embodiments, is present in the chemical composition in an amount ranging from 0.01 weight percent to 2.7 weight percent or from 0.01 weight percent to 2.5 weight percent. In some embodiments, an inorganic extrusion aid is present in the chemical composition in an amount ranging from 0.01 weight percent to 2.3 weight percent or from 0.01 weight percent to 2 weight percent. In some embodiments, an inorganic extrusion aid is present in the chemical composition in an amount ranging from 0.01 weight percent to 1.7 weight percent or from 0.01 weight percent to 1.5 weight percent. In some embodiments, an inorganic extrusion aid is present in the chemical composition in an amount ranging from 0.01 weight percent to 1.3 weight percent of from 0.01 weight percent to 1 weight percent. In some embodiments, an inorganic extrusion aid is present in the chemical composition in an amount ranging from 0.01 weight percent to 0.7 weight percent or from 0.01 weight percent to 0.5 weight percent. An inorganic extrusion aid, in some embodiments, is present in the chemical composition in an amount ranging from 0.01 weight percent to 0.1 weight percent.

In some embodiments, an inorganic extrusion aid, including any clay described herein, is not present or not substantially present in the chemical composition forming the outer peripheral wall and/or the inner partition walls of a structural catalyst body.

Moreover, the chemical composition of the outer peripheral wall and/or the inner partition walls of a structural catalyst body described herein also comprises at least 0.1 weight percent a catalytically active metal functional group comprising vanadium. As described herein, the vanadium, in some embodiments, is part of the chemical composition extruded to form the outer peripheral wall and inner partition walls of a structural catalyst body. Alternatively, in some embodiments, the vanadium is added to the chemical composition of the outer peripheral wall and/or inner partition walls by impregnation after formation of the walls.

In some embodiments, the chemical composition of the outer peripheral wall and/or inner partition walls comprises vanadium in an amount up to about 10 weight percent. The chemical composition, in some embodiments, comprises vanadium in an amount up to about 7 weight percent or up to about 5 weight percent. In some embodiments, the chemical composition comprises vanadium in an amount up to about 4 weight percent or up to about 3 weight percent.

The chemical composition of the outer peripheral wall and/or the inner partition walls of a structural catalyst body described herein, in some embodiments, comprises vanadium in an amount ranging from about 0.1 weight percent to about 10 weight percent. In some embodiments, the chemical composition comprises vanadium in an amount ranging from about 0.5 weight percent to about 5 weight percent. In some embodiments, the chemical composition comprises vanadium in an amount ranging from about 0.5 weight percent to about 2 weight percent. The chemical composition, in some embodiments, comprises vanadium in an amount ranging from about 0.7 weight percent to about 3 weight percent or from about 1 weight percent to about 4 weight percent. In some embodiments, the chemical composition comprises vanadium in an amount ranging from about 2 weight percent to about 3 weight percent.

In some embodiments, vanadium is present in the chemical composition of the outer peripheral wall and/or inner partition walls as a vanadium oxide. In some embodiments, vanadium oxide present in the chemical composition of the outer peripheral wall and/or inner partition walls of a structural catalyst body described herein is non-crystalline or substantially non-crystalline in nature. In some embodiments, for example, the chemical composition of a structural catalyst body described herein comprises crystalline V₂O₅ [Chemical Abstracts Service (CAS) No. 1314-62-1] in an amount less than or equal to 0.1 weight percent as determined by X-ray diffraction (XRD) with reference to ICDD powder diffraction file 00-041-1426. The chemical composition, in some embodiments, comprises crystalline V₂O₅ in an amount less than or equal to 0.05 weight percent as determined by X-ray diffraction with reference to ICDD powder diffraction file 00-041-1426. In some embodiments, the chemical composition comprises crystalline V₂O₅ in an amount less than or equal to 0.04 weight percent as determined by X-ray diffraction with reference to ICDD powder diffraction file 00-041-1426.

In some embodiments, the catalytically active metal functional group of the chemical composition comprises metals in addition to vanadium. In some embodiments, the catalytically active metal functional group further comprises tungsten, molybdenum, ruthenium, platinum, palladium, rhenium, iridium, cerium, gold or other noble metals or mixtures thereof. In some embodiments, for example, the catalytically active metal functional group further comprises a tungsten oxide (e.g. WO₃) or molybdenum oxide (e.g. MoO₃) or mixtures thereof. The amount and identity of catalytically active metals in addition to vanadium can be selected according to various factors including the intended catalytic functionality of the structural catalyst body. In some embodiments, for example, the chemical composition comprises molybdenum in an amount ranging from about 0.01 weight percent to about 10 weight percent or from about 0.01 weight percent to about 5 weight percent. The chemical composition, in some embodiments, comprises tungsten in an amount ranging from about 0.01 weight percent to about 10 weight percent.

When comprising additional metals, the catalytically active metal functional group, in some embodiments, comprises 1-30% by weight of the chemical composition forming the outer peripheral wall and/or inner partition walls of a structural catalyst body described herein. In some embodiments, when comprising additional metals, the catalytically active metal functional group comprises 5-15% by weight or 10-20% by weight of the chemical composition forming the outer peripheral wall and/or inner partition walls of the structural catalyst body.

In some embodiments, the chemical composition of the outer peripheral wall and/or inner partition walls is uniform or substantially uniform. In some embodiments, the chemical composition is heterogeneous. In some embodiments, for example, the chemical composition of an inner partition wall has one or more gradients of catalytic material. In some embodiments, an inner partition wall has a first surface and a second surface, wherein a gradient of catalytic material is present along a width of the first surface. In some embodiments, catalytic material of the gradient decreases in amount at the periphery of the width of the first surface. In some embodiments, catalytic material of the gradient increases in amount along a central region of the width of the first surface. In some embodiments, an inner partition wall further comprises a gradient of catalytic material along a width of the second surface. In some embodiments, a gradient of catalytic material along a width of the second surface mirrors the gradient of catalytic material along the first surface of the inner partition wall. In some embodiments, an inner partition wall comprises a gradient of bulk catalytic material along a width of the first surface. Moreover, in some embodiments, an interior surface of the outer peripheral wall comprises one or more gradients of catalytic material described herein for the inner partition wall.

The formation and/or impregnation of the outer peripheral wall and/or inner partition walls with a catalytically active chemical composition described herein, in some embodiments, disposes catalytically active metals throughout the outer peripheral wall and/or inner partitions walls. This is in contrast to catalyst bodies wherein catalytic material is coated on an inert or catalytically inactive structural support such as those described in U.S. Pat. No. 5,494,881 to Machida et al.

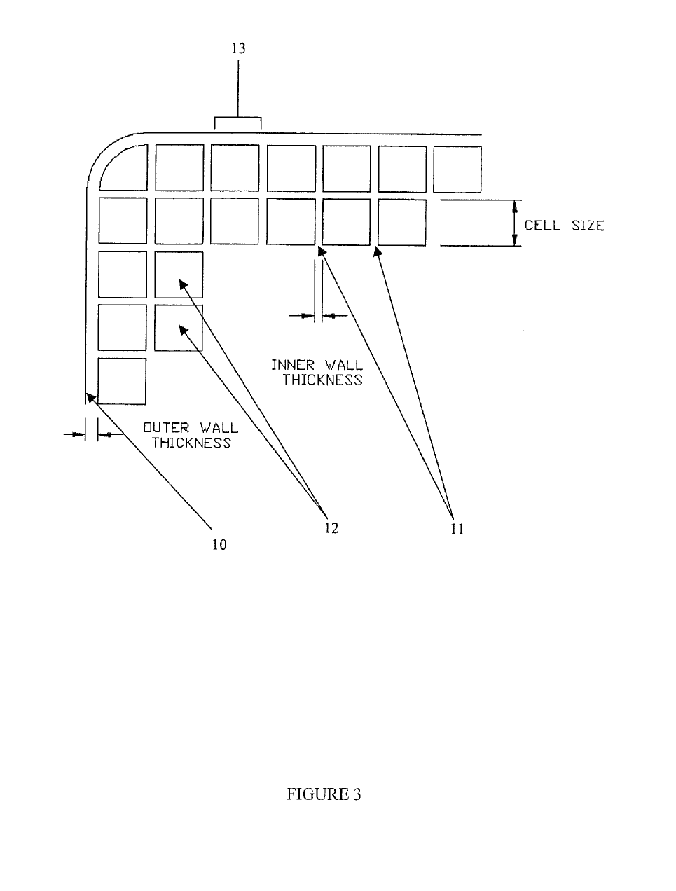

FIG. 3 illustrates a sectional view of a structural catalyst body according to one embodiment described herein. The inner partition walls (11) and their junctions with the outer peripheral wall (10) serve as boundaries for adjacent flow channels (12). When a portion of the outer peripheral wall (10) serves as a boundary for a flow channel (12), that portion may be referred to as an outer peripheral wall segment (13). Outer peripheral wall segments (13) are important in determining the total wall count for a structural catalyst body described herein. Moreover, in some embodiments, the axial dimension of a flow channel (12) can vary depending on the application of the catalyst body. The outside of the outer peripheral wall bounds the overall cross-sectional size dimension and overall geometrical cross-sectional shape of the structural catalytic body.

In some embodiments of a structural catalyst body described herein, the cross-sectional profile of the flow channels can be nominally polygonal such as triangular, square, rectangular or hexagonal. In some embodiments, the cross-sectional profile of the flow channels can be corrugated, round, oval or combinations with polygonal and curved shapes such as annular sectors. In some embodiments, the cross-sectional profile of the outer peripheral wall of a structural catalyst body described herein can be square, rectangular, round, oval, circular sectors such as pie slices or quadrants or any other geometric shape or shapes convenient for a given application.

In some embodiments, a structural catalyst body described herein can have an average cross-sectional size dimension characterized by a hydraulic diameter of greater than or equal to about 75 mm. In some embodiments, a structural catalyst body can have a hydraulic diameter of greater than or equal to about 100 mm. In some embodiments, a structural catalyst body has a hydraulic diameter greater than or equal to about 120 mm or greater than or equal to about 130 mm. In some embodiments, a structural catalyst body has a hydraulic diameter greater than or equal to about 140 mm. In some embodiments, a structural catalyst body can have a hydraulic diameter of greater than or equal to 150 mm.

In some embodiments, a structural catalyst body has a hydraulic diameter ranging from about 100 mm to about 170 mm. In some embodiments, a structural catalyst body has a hydraulic diameter ranging from about 120 mm to about 160 mm or from about 130 mm to about 150 mm.

The hydraulic diameter of a catalyst body is defined as being equal to the cross-sectional area perpendicular to the direction of flow of the catalyst body multiplied by four and divided by the value of the outer perimeter of the outer peripheral wall. When a structural catalyst body displays a circular cross-sectional geometry, the hydraulic diameter is equal to the diameter of the circular cross-sectional area. In the case of a square cross-sectional geometry, the hydraulic diameter is equal to the length or width of a side.

In some embodiments, a structural catalyst body described herein can have a macroporosity of greater than or equal to 0.01 cc/g in pores of diameter ranging from 600-5,000 Angstroms. In some embodiments, a structural catalyst body can have a macroporosity greater than or equal to 0.05 cc/g in pores of diameter ranging from 600-5,000 Angstroms. In some embodiments, a structural catalyst body can have a macroporosity greater than or equal to 0.09 cc/g in pores of diameter ranging from 600-5,000 Angstroms. A structural catalyst body, in some embodiments, can have a macroporosity ranging from 0.01 cc/g to 0.35 cc/g in pores of diameter ranging from 600-5,000 Angstroms. In some embodiments, a structural catalyst body can have a macroporosity of at least 0.24 cc/g in pores of diameter ranging from 600-5,000 Angstroms.

The macroporosity of a catalyst body described herein, in some embodiments, is determined from analysis of the appropriate pore size ranges of the catalyst body pore size distributions. Pore size distributions and porosities or total pore volumes in some embodiments are measured according to ASTM Method UOP578-02 “Automated Pore Volume and Pore Size Distribution of Porous Substances by Mercury Porosimetry,” wherein sample preparation for measurements include an oven pre-treatment at 300° C. for one (1) hour as opposed to the vacuum oven pretreatment at 150° C. for eight (8) hours as called for by the ASTM procedure. The remaining steps in the ASTM procedure are followed without alteration.

Additionally, a structural catalyst body described herein, in some embodiments, has a transverse compressive strength of at least 1.5 kg/cm². In some embodiments, a structural catalyst body has a transverse compressive strength of at least 3 kg/cm² or at least 3.5 kg/cm². In some embodiments, a structural catalyst body has a transverse compressive strength of at least 4 kg/cm². In some embodiments, a structural catalyst body has a transverse compressive strength of at least 10 kg/cm² or at least 20 kg/cm². In some embodiments, a structural catalyst body has a transverse compressive strength of at least 30 kg/cm².

In some embodiments, a structural catalyst body has a transverse compressive strength ranging from about 1.5 kg/cm² to about 50 kg/cm² or from about 3 kg/cm² to about 35 kg/cm².

The transverse compressive strength of a structural catalyst body described herein, in some embodiments, is measured with a compressive testing apparatus such as Tinius Olson 60,000 lb. Super “L” Compression Testing Machine that displays a maximum compression load of 30,000 kg and is commercially available from Tinius Olsen of Willow Grove, Pa. Samples for transverse compressive strength testing may be prepared by cutting a structural catalyst into sections typically of 150 mm in length, but at least 50 mm in length, wherein each section can serve as an individual test sample.

Ceramic wool of 6 mm thickness may be spread under and over the pressure surface of the sample, and the wrapped sample set in a vinyl bag in the center of the pressure plates. The pressure plates used in the testing may be stainless steel with dimensions of 160 mm×160 mm. Transverse compression strength is quantified with the side surface on the bottom with the compressive load applied in the direction parallel to the cross-section of the honeycomb structure and perpendicular to the partition walls. The compressive load is thus applied in the direction perpendicular to the direction of flow in the flow channels. The compressive load can be applied as delineated in Table 1.

TABLE 1
Compressive Loads

| Full Scale Load | Compression Speed |
|---|---|
| 3,000 kg | 25 kg/s |
| 6,000 kg | 50 kg/s |
| 15,000 kg | 125 kg/s |

The maximum transverse compressive load W (kg) withstood by the samples is registered by the apparatus. The transverse compressive strength is subsequently calculated from the maximum compressive load in kilograms-force (kg_{f}) by dividing the value of the maximum compressive load by the surface area over which the load was applied.

In some embodiments wherein the catalyst body does not lie flat, such as when the catalyst body has an overall circular or oval cross-sectional geometry, a subsection of the catalyst body is cut from the overall sample for testing. The subsection is cut so as to produce a sample with upper and lower flat surfaces. The remainder of the strength testing proceeds in a manner consistent with that previously described.

Embodiments described herein contemplate a structural catalyst body comprising any combination of inner partition wall thickness, macroporosity, hydraulic diameter and/or transverse compressive strength recited herein. In one embodiment, for example, a structural catalyst body described herein has a inner partition wall thickness less than 0.5 mm, a macroporosity of greater than or equal to 0.01 cc/g in pores of diameter ranging from 600-5,000 Angstroms, a hydraulic diameter of at least 100 mm and a transverse compressive strength of at least 1.5 kg/cm².

In another aspect, methods of producing structural catalyst bodies are described herein. In some embodiments, a method of producing a structural catalyst body comprises providing a chemical composition comprising 50-99.9% by weight an inorganic oxide composition, less than 3% by weight an inorganic extrusion aid and at least 0.1% by weight a catalytically active metal functional group comprising vanadium, forming the chemical composition into a monolithic structure comprising an outer peripheral wall and a plurality of inner partition walls having an average thickness less than about 0.5 mm and heating the monolithic structure to provide the structural catalyst body having a crystalline vanadium pentoxide content less than 0.1 weight percent as determined by X-ray diffraction with reference to ICDD powder diffraction file 00-041-1426. In some embodiments, the structural catalyst body has crystalline vanadium pentoxide content less than 0.05 weight percent as determined by X-ray diffraction with reference to ICDD powder diffraction file 00-041-1426.

Structural catalyst bodies produced according to methods described herein can have any property or combination of properties recited herein for the structural catalyst bodies.

In some embodiments of a method described herein, a chemical composition is provided by mixing up to 50-99.9% by weight an inorganic oxide composition, less than 3% by weight an inorganic extrusion aid and at least 0.1 weight percent a catalytically active metal functional group comprising vanadium, or a precursor which yields a catalytically active metal functional group comprising vanadium. In some embodiments, the identity and amount of each component of the chemical composition can be varied according to the ranges set forth hereinabove for each component. In some embodiments, for example, an inorganic extrusion aid comprising a clay is added in an amount ranging from 0.01 weight percent to 3 weight percent or from about 0.01 weight percent to 2.7 weight percent. Moreover, in some embodiments, no or substantially no inorganic extrusion aid comprising clay is added to the chemical composition. Additionally, in some embodiments, vanadium is added to the chemical composition in an amount ranging from about 0.1 weight percent to about 10 weight percent or from about 0.5 weight percent to about 7 weight percent.

In some embodiments, vanadium is added to the chemical composition as a vanadium compound. In some embodiments, for example, vanadium is added to the chemical composition as one or more vanadyl salts, including vanadyl oxalate, vanadyl sulfate or ammonium metavanadate. In some embodiments, vanadium is added to the chemical composition in solution form, thereby impregnating the chemical composition with vanadium catalytic material. In some embodiments, vanadium is added to the chemical composition in solid form, such as in the form of one or more solid salts.

The resulting component mixture of the chemical composition can be kneaded into a moldable or extrudable substance and subsequently extruded from an extrusion molding machine to form a structural catalyst body comprising an outer peripheral wall, inner partition walls and longitudinal flow channels as described herein. In some embodiments, the chemical composition is mixed and/or kneaded for a time period sufficient to provide a uniform or substantially uniform chemical composition.

In some embodiments when the chemical composition is extruded to form the structural catalyst body, the extrusion formulation can comprise any number of peptizing agents, binding agents, organic extrusion aids, lubricants, plasticizers, surfactants, reinforcement agents, and the like to assist in the extrusion process and/or generate the desired structural and/or pore properties for an intended application. Examples of materials that may be included in an extrusion formula include, but are not limited to, glass fibers or strands, silicon carbide fibers, inorganic acids (e.g. phosphoric acid, nitric acid, etc.) organic acids (e.g. acetic acid, citric acid, formic acid, etc.), salts of organic acids (e.g. ammonium formate, ammonium acetate, ammonium citrate, etc.) cellulose compounds, polysaccharides, starches, polyethylene oxide, stearic alcohols, alcohols, graphite, stearic acid, amines, oils, fats, fatty alcohols, ethoxylated fatty alcohols, fatty acids and/or polymers.

The extrusion system may include extruder machines, a filter or screen, and an extrusion die. The filter or screen may be utilized to facilitate passage of the mixture through the die, for example, to reduce clogging of the die, without removing filler, binders, and/or reinforcement aids that provide advantageous product properties. In some embodiments, for example, the filter or screen has opening sizes less than that of the wall thickness of the structural catalyst body. Moreover, in some embodiments, the filter or screen has opening sizes and/or geometries suitable for passing reinforcing aids such as glass or silicon carbide reinforcing fibers.

It is generally desirable, when extruding structural catalyst bodies described herein to use sufficient energy to achieving intimate mixing of the compositional ingredients while minimizing energy that may have an adverse impact on particle packing characteristics that provide advantageous product properties. In some embodiments, additional energy is utilized in the mixing equipment to increase form-stability, and in the extrusion system to move the extrusion mixture through the extruder machines, filter or screen and die. As set forth above, various lubricants and extrusion aids may be utilized in the starting composition for the catalyst body to minimize this additional energy. Other means of reducing additional energy known in the art, include maximizing mixer and extruder efficiency and minimizing wall friction in the screen and die.

The extruded catalyst body, in some embodiments, is heated or calcined to provide the structural catalyst body having a crystalline vanadium pentoxide (CAS No. 1314-62-1) content less than 0.1 weight percent as determined by X-ray diffraction with reference to ICDD powder diffraction file 00-041-1426. In some embodiments, the heated or calcined structural catalyst body has a crystalline vanadium pentoxide content less than 0.05 weight percent as determined by X-ray diffraction with reference to ICDD powder diffraction file 00-041-1426.

In some embodiments, the structural catalyst body is heated at a temperature of up to about 850° C. In some embodiments, the structural catalyst body is heated at a temperature ranging from about 300° C. to about 750° C. In some embodiments, the structural catalyst body is heated at a temperature ranging from about 500° C. to about 700° C. or from about 300° C. to about 500° C.

In some embodiments, the structural catalyst body is further coated or impregnated with additional catalytic material. In some embodiments, for example, the structural catalyst body is coated or impregnated with any metal or catalytically active species described herein.

In some embodiments, a method of producing a structural catalyst body comprises providing a chemical composition comprising up to 100% by weight an inorganic oxide composition and less than 3% by weight an inorganic extrusion aid, forming the chemical composition into a monolithic structure comprising an outer peripheral wall and a plurality of inner partition walls having an average thickness less than about 0.5 mm, impregnating the monolithic structure with at least 0.1 percent by weight a catalytically active metal functional group comprising vanadium and heating the monolithic structure to provide the structural catalyst body having a crystalline vanadium pentoxide content less than 0.1 weight percent as determined by X-ray diffraction with reference to ICDD powder diffraction file 00-041-1426. In some embodiments, the structural catalyst body has a crystalline vanadium pentoxide content less than 0.05 weight percent as determined by X-ray diffraction with reference to ICDD powder diffraction file 00-041-1426.

In some embodiments, the monolithic structure formed of the chemical composition comprising up to 100% by weight an inorganic oxide composition and less than 3% by weight an inorganic extrusion aid is heated prior to impregnating with the catalytically active metal functional group. In some embodiments, the monolithic structure is dried prior to impregnation with the catalytically active metal functional group. In some embodiments, the monolithic structure is calcined prior to impregnation with the catalytically active metal functional group.

In some embodiments, the structural catalyst body comprising up to 100% by weight an inorganic oxide composition and less than 3% by weight an inorganic extrusion aid is formed by extrusion as described hereinabove. Moreover, in some embodiments, impregnating the monolithic structure with at least 0.1 percent by weight a catalytically active metal functional group comprising vanadium comprises disposing at least a portion of the structural catalyst body in an aqueous solution of a salt of vanadium or vanadium oxide. In some embodiments, an aqueous solution comprises one or more vanadyl salts, including vanadyl oxalate, vanadyl sulfate or ammonium metavanadate.

In some embodiments, the aqueous solution can comprise one or more metal and/or metal oxide salts in addition to vanadium. In some embodiments, an aqueous solution further comprises a tungsten salt such as ammonium metatungstate. In some embodiments, the aqueous solution further comprises a molybdenum salt, such as ammonium molybdate, sodium molybdate or mixtures thereof.

In some embodiments, an impregnated structural catalyst body is dried in a manner to induce one or more gradients of catalytic material described herein.

In another aspect, methods of inhibiting the formation of crystalline vanadium pentoxide in a structural catalyst body are described herein. In some embodiments, a method of inhibiting the formation of crystalline vanadium pentoxide, V₂O₅ (CAS No. 1314-62-1), in a structural catalyst body comprises varying the amount of inorganic extrusion aid in the chemical composition forming the outer peripheral wall and/or inner partition walls of the structural catalyst body, the crystalline vanadium pentoxide content determined by X-ray diffraction with reference to ICDD powder diffraction file 00-041-1426. In some embodiments, varying the amount of inorganic extrusion aid comprises reducing the amount of inorganic extrusion aid in the chemical composition forming the outer peripheral wall and/or inner partition walls of the structural catalyst body. In some embodiments, reducing the amount of inorganic extrusion aid comprises providing a chemical composition comprising the inorganic extrusion aid in an amount less than 3% by weight. In some embodiments, reducing the amount of inorganic extrusion aid comprises providing a chemical composition comprising the inorganic extrusion aid in an amount less than 2% by weight. reducing the amount of inorganic extrusion aid comprises providing a chemical composition comprising the inorganic extrusion aid in an amount less than 1% by weight. Moreover, in some embodiments, reducing the amount of inorganic extrusion aid comprises providing a chemical composition comprising no or substantially no inorganic extrusion aid.

In some embodiments, an inorganic extrusion aid in methods of inhibiting the formation of crystalline vanadium pentoxide in a structural catalyst body comprises any inorganic extrusion aid described herein including, but not limited to, any clay described herein.

In another aspect, the present invention provides methods of reducing the nitrogen oxide content of a fluid. In some embodiments, a method of reducing the nitrogen oxide content of a fluid comprises flowing the fluid through a structural catalyst body comprising an outer peripheral wall and a plurality of inner partition walls having an average thickness less than about 0.5 mm, the outer peripheral wall and the inner partition walls having dispersed throughout a chemical composition comprising 50-99.9% by weight an inorganic oxide composition, less than 3% by weight an inorganic extrusion aid and at least 0.1% by weight a catalytically active metal functional group comprising vanadium, the structural catalyst body having a crystalline vanadium pentoxide content less than 0.1 weight percent as determined by X-ray diffraction with reference to ICDD powder diffraction file number 00-041-1426 and selectively catalytically reducing at least some of the nitrogen oxides in the fluid. In some embodiments, a structural catalyst body of a method of reducing the nitrogen oxide content of a fluid can comprise any compositional and/or structural parameters described herein for a catalyst body.

In some embodiments, the selective catalytic reduction of nitrogen oxides is conducted in the presence ammonia (NH₃) or any chemical compound containing nitrogen that can decompose or react to form ammonia prior to contact with the catalyst or upon contact with the catalyst including, but not limited to, urea, [CO(NH₂)₂], cyanuric acid [2,4,6-trihydroxy-1,3,5-triazine] or isocyanic acid [HNCO] or mixtures thereof.

In some embodiments, a fluid flowed through the structural catalyst body comprises an exhaust gas or a flue gas stream. In some embodiments, an exhaust gas stream or flue gas stream suitable for treatment with a structural catalyst body described herein is generated by a stationary combustion source. In some embodiments, a stationary combustion source is an electrical generating plant or system. In some embodiments, an exhaust gas stream or a flue gas stream suitable for treatment with a structural catalyst body described herein is generated by a mobile combustion source. A mobile combustion source, in some embodiments, is an automobile, bus, truck, construction machinery, railway vehicles and apparatus or various marine vessels. In some embodiments, structural catalyst bodies described herein are suitable for use treating exhaust gases generated in heavy duty diesel applications.

In some embodiments, the temperature of an exhaust or flue gas flowing through a structural catalyst body described herein ranges from about 150° C. to about 700° C. In some embodiments, the temperature of the exhaust gas or flue gas flowing through a structural catalyst body described herein is greater than about 700° C.

Embodiments of compositions and methods described herein are further illustrated by the following non-limiting examples.

### Example 1

### Structural Catalyst Body

A structural catalyst body according to one embodiment described herein was prepared by extrusion of a chemical composition according to the procedures set forth above, the chemical composition having compositional parameters described herein. Energy loss was minimized during the extrusion process by the use of a lubricant and die clogging was minimized by the use of a screen as described herein. The extruded structural catalyst body was calcined at a temperature of 500° C. for a time period of 5 hours. The compositional parameters and physical properties of the structural catalyst body are summarized in Table 2. The chemical composition of the structural catalyst body comprised 82.0% by weight titania, 7.4% by weight tungsten oxide, 1.6% by weight vanadium oxide and 9.0% by weight glass fibers and minor species.

TABLE 2
Structural Catalyst Body Parameters

| Component | Example 1 |
|---|---|
| Titanium Dioxide (TiO₂) | 82.0 wt. % |
| Tungsten oxide | 7.4 wt. % |
| Vanadium oxide | 1.6 wt. % |
| Glass fiber and minor species | 9.0 wt. % |
| Nominal Cross-Sectional Shape | Square |
| Inner Partition Wall Thickness (mm) | 0.22 |
| Opening between Inner Partition Walls (mm) | 1.92 |
| Porosity (cm³/g) | 0.3 |

The structural catalyst body was subsequently analyzed by X-ray diffraction to determine the amount crystalline V₂O₅ (CAS No. 1314-62-1) present in the structural catalyst body. To facilitate mounting in an X-ray diffractometer, a planar section of an inner partition wall having dimensions of 4 mm×15 mm was removed from the structural catalyst body with the blade of a knife. The planar section of the inner partition wall was mounted on a soft clay support in the sample holder of a PANalytical X'pert MPD Pro diffractometer (200 nm diameter) having a WO goniometer in which the X-ray tube and X-ray detector rotate to collect the diffraction data. The planar section of the inner partition wall was of sufficient thickness to prevent X-rays from reaching the soft clay support.

The parameters of the XRD analysis of the structural catalyst body are set forth in Table 3.

TABLE 3
XRD Parameters
PANanlyitcal X'pert MPD Pro Diffractometer (200 nm diameter)

Cu LFF X-ray tube
Power Level - 45 kV/40 mA
Soller Slits (Incident and Receiving) - 0.04 Rad
Incident Beam Mask - 10 mm variable
Fixed Anti-scatter Slit - 9.1 mm
Pixel Detector (4.016 active length with 256 channels)
Scan Range - 19° to 27° (nominal)
Step Size 0 0.04727°
Counting Time - 40,000 sec/step nominal

The XRD parameters provided in Table 3 set the limit of detection of crystalline V₂O₅ to 0.05 weight percent, the limit of detection based on V₂O₅ peaks in the diffractogram equal to 3σ above the background noise level at the expected peak positions for V₂O₅ in accordance with ICDD powder diffraction file 00-041-1426.

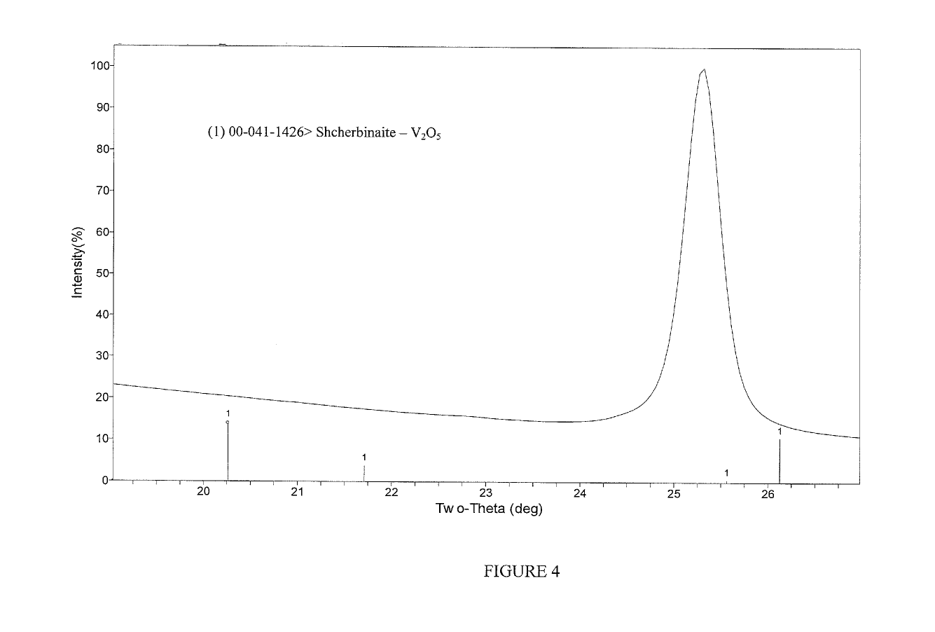

The results of the XRD analysis of the structural catalyst body are provided in the diffractogram of FIG. 4. As illustrated by the diffractogram, no crystalline V₂O₅ was detected in the structural catalyst body down to the limit of detection of 0.05 weight percent. Peaks at the expected peak positions for crystalline V₂O₅ (CAS No. 1314-62-1) according to ICDD powder diffraction file 00-041-1426 were absent indicating that crystalline V₂O₅, if present at all, was present in an amount less than the 0.05 weight percent limit of detection.

### Example 2

### Prior Art Structural Catalyst Body

In contrast to Example 1, a prior art structural catalyst body comprising an inorganic extrusion aid of clay in excess of 3% by weight was prepared by extrusion according to procedures set forth herein. The extruded structural catalyst body was calcined at a temperature of 550° C. for a time period of 5 hours. The compositional parameters and physical properties of the structural catalyst body are summarized in Table 4.

TABLE 4
Structural Catalyst Body Parameters

| Component | Example 2 |
|---|---|
| Titanium Dioxide (TiO₂) | 78.3 wt. % |
| Tungsten oxide | 9.2 wt. % |
| Vanadium oxide | 0.8 wt. % |
| Clay | 3.3 wt. % |
| Glass fiber and minor species | 8.4 wt. % |
| Nominal Cross-Sectional Shape | Square |
| Inner Partition Wall Thickness (mm) | 0.22 |
| Opening between Timer Partition Walls (mm) | 1.92 |
| Porosity (cm³/g) | 0.3 |

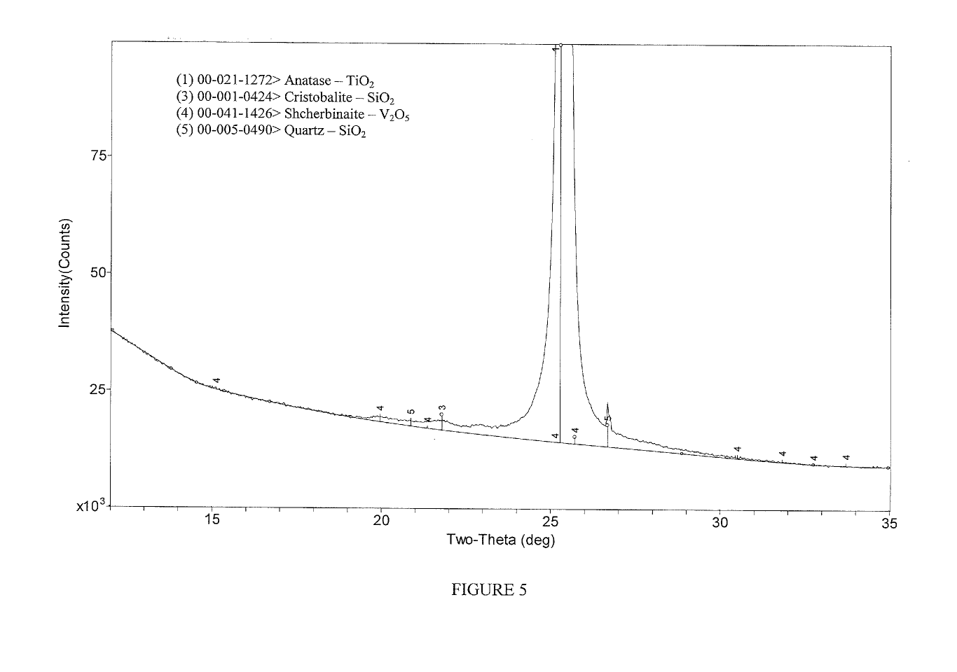

The structural catalyst body was subsequently analyzed by X-ray diffraction to determine the amount of crystalline V₂O₅ present in the catalyst body. X-ray diffraction analysis was conducted in accordance with Example 1. The results of the XRD analysis of the structural catalyst body are provided in the diffractogram of FIG. 5. As illustrated in the diffractogram, the structural catalyst body contained crystalline V₂O₅ in an amount of 0.7 weight percent.

Various embodiments of the invention have been described in fulfillment of the various objectives of the invention. It should be recognized that these embodiments are merely illustrative of the principles of the present invention. Numerous modifications and adaptations thereof will be readily apparent to those skilled in the art without departing from the spirit and scope of the invention.

That which is claimed is:

1. A structural catalyst body comprising:
an outer peripheral wall and a plurality of inner partition walls having an average thickness less than about 0.5 mm, the outer peripheral wall and the inner partition walls having dispersed throughout a chemical composition comprising 50-99.9% by weight an inorganic oxide composition, less than 3% by weight an inorganic extrusion aid and at least 0.1% by weight a catalytically active metal functional group comprising vanadium, the structural catalyst body having a crystalline vanadium pentoxide content less than 0.1 weight percent as determined by X-ray diffraction with reference to International Centre for Diffraction Data (ICDD) powder diffraction file 00-041-1426.

2. The structural catalyst body of claim 1 having a crystalline vanadium pentoxide content less than 0.05 weight percent as determined by X-ray diffraction with reference to ICDD powder diffraction file 00-041-1426.

3. The structural catalyst body of claim 1, wherein the structural catalyst body has no or substantially no crystalline vanadium pentoxide content as determined by X-ray diffraction with reference to International Centre for Diffraction Data (ICDD) powder diffraction file 00-041-1426.

4. The structural catalyst body of claim 1, wherein the inorganic extrusion aid comprises clay.

5. The structural catalyst body of claim 1, wherein the inner partition walls have an average thickness less than about 0.3 mm.

6. The structural catalyst body of claim 1, wherein the inner partition walls have an average thickness less than about 0.25 mm.

7. The structural catalyst body of claim 1, wherein the chemical composition comprises at least 1% by weight a catalytically active metal functional group comprising vanadium.

8. The structural catalyst body of claim 1, wherein the chemical composition comprises at least 1.5% by weight a catalytically active metal functional group comprising vanadium.

9. The structural catalyst body of claim 5, wherein the chemical composition comprises no or substantially no inorganic extrusion aid.

10. The structural catalyst body of claim 1, wherein the chemical composition comprises an inorganic extrusion aid in an amount ranging from about 0.01 weight percent to about 2.7 weight percent.

11. The structural catalyst body of claim 9, wherein the structural catalyst body has a hydraulic diameter of at least about 100 mm.

12. The structural catalyst body of claim 11, wherein the structural catalyst body has transverse compressive strength of at least about 1.5 kg/cm².

13. The structural catalyst body of claim 11, wherein the structural catalyst body has transverse compressive strength of at least about 3.5 kg/cm².

14. The structural catalyst body of claim 12, wherein the chemical composition comprises at least 1% by weight a catalytically active metal functional group comprising vanadium.

15. The structural catalyst body of claim 1, wherein the chemical composition comprises no or substantially no inorganic extrusion aid.

16. The structural catalyst body of claim 1, wherein the catalytically active metal functional group further comprises tungsten, molybdenum, ruthenium, platinum, palladium, rhenium, iridium, cerium, gold or other noble metals or mixtures thereof.

17. The structural catalyst body of claim 16, wherein the chemical composition comprises at least 3% by weight of an oxide of molybdenum.

18. The structural catalyst body of claim 16, wherein the chemical composition comprises at least 5% by weight of an oxide of tungsten.

19. A structural catalyst body comprising:
an outer peripheral wall and a plurality of inner partition walls having an average thickness less than about 0.5 mm, the outer peripheral wall and the inner partition walls having dispersed throughout a chemical composition comprising 50-99.9% by weight TiO₂, less than 3% by weight an inorganic extrusion aid and at least 0.1% by weight a catalytically active metal functional group comprising vanadium, the structural catalyst body having a crystalline vanadium pentoxide content less than 0.1 weight percent as determined by X-ray diffraction with reference to International Centre for Diffraction Data (ICDD) powder diffraction file 00-041-1426.

20. The structural catalyst body of claim 19 having a crystalline vanadium pentoxide content less than 0.05 weight percent as determined by X-ray diffraction with reference to ICDD powder diffraction file 00-041-1426.

21. The structural catalyst body of claim 19, wherein the structural catalyst body has no or substantially no crystalline vanadium pentoxide content as determined by X-ray diffraction with reference to International Centre for Diffraction Data (ICDD) powder diffraction file 00-041-1426.

22. The structural catalyst body of claim 19, wherein the inorganic extrusion aid comprises clay.

23. The structural catalyst body of claim 19, wherein the inner partition walls have an average thickness less than about 0.3 mm.

24. The structural catalyst body of claim 19, wherein the inner partition walls have an average thickness less than about 0.25 mm.

25. The structural catalyst body of claim 19, wherein the chemical composition comprises at least 1% by weight a catalytically active metal functional group comprising vanadium.

26. The structural catalyst body of claim 19, wherein the chemical composition comprises at least 1.5% by weight a catalytically active metal functional group comprising vanadium.

27. The structural catalyst body of claim 23, wherein the chemical composition comprises no or substantially no inorganic extrusion aid.

28. The structural catalyst body of claim 19, wherein the chemical composition comprises an inorganic extrusion aid in an amount ranging from about 0.01 weight percent to about 2.7 weight percent.

29. The structural catalyst body of claim 27, wherein the structural catalyst body has a hydraulic diameter of at least about 100 mm.

30. The structural catalyst body of claim 29, wherein the structural catalyst body has transverse compressive strength of at least about 1.5 kg/cm².

31. The structural catalyst body of claim 29, wherein the structural catalyst body has transverse compressive strength of at least about 3.5 kg/cm².

32. The structural catalyst body of claim 30, wherein the chemical composition comprises at least 1% by weight a catalytically active metal functional group comprising vanadium.

33. The structural catalyst body of claim 19, wherein the chemical composition comprises no or substantially no inorganic extrusion aid.

34. The structural catalyst body of claim 19, wherein the catalytically active metal functional group further comprises tungsten, molybdenum, ruthenium, platinum, palladium, rhenium, iridium, cerium, gold or other noble metals or mixtures thereof.

35. The structural catalyst body of claim 34, wherein the chemical composition comprises at least 3% by weight an oxide of molybdenum.

36. The structural catalyst body of claim 34, wherein the chemical composition comprises at least 5% by weight an oxide of tungsten.

37. A method of inhibiting the formation of crystalline vanadium pentoxide in a structural catalyst body comprising reducing the amount of inorganic extrusion aid in the chemical composition forming the outer peripheral wall and/or inner partition walls of the structural catalyst body, the crystalline vanadium pentoxide content determined by X-ray diffraction with reference to ICDD powder diffraction file 00-041-1426.

38. The method of claim 37, wherein reducing the amount of inorganic extrusion aid comprises providing a chemical composition comprising the inorganic extrusion aid in an amount less than 3% by weight.

39. The method of claim 37, wherein reducing the amount of inorganic extrusion aid comprises providing a chemical composition comprising no or substantially no inorganic extrusion aid.
